(19) United States
(12) Patent Application Publication
(10) Pub. No.: US 2026/0219171 A1
(43) Pub. Date: Jul. 30, 2026

(54) METHOD FOR OPTICALLY CHARACTERIZING A TRANSPARENT OR SEMITRANSPARENT OBJECT, AND OPTICAL COHERENCE TOMOGRAPHY SYSTEM

(71) Applicant: HERAEUS CONSULTING & IT SOLUTIONS GMBH, Hanau (DE)

(72) Inventors: Thomas HORNUNG, Hanau (DE); Thorsten FÜHRER, Darmstadt (DE); Thomas WALTHER, Darmstadt (DE)

(21) Appl. No.: 19/147,514

(22) PCT Filed: Jan. 11, 2024
(86) PCT No.: PCT/EP2024/050531

§ 371 Date: Jul. 11, 2025

(30) Foreign Application Priority Data
Jan. 13, 2023 (DE) 10 2023 100 795.5

(51) Int. Cl. G01N 21/31

(52) U.S. Cl. CPC G01N 21/31; G01N 2201/0636; G01N 2201/105

(57) ABSTRACT

The underlying invention relates in particular to a method for optically characterizing a transparent or semitransparent object and to an optical coherence tomography system. According to the method, object dimensions (wall thickness, inside diameter, outside diameter), object distances and/or object positions are determined on the basis of optical coherence tomography, wherein, as a laser source, a swept-source laser source having a coherence length in the decimeter range to meter range is used, and in order to determine absolute distances, dimensions and/or positions a reference substrate is used in the beam path of the light source, the reference substrate comprising a partially reflecting optical unit which is stationary in the beam path.

The underlying invention relates in particular to a method for optically characterizing transparent or semitransparent objects, and to an optical coherence tomography system.

In the prior art, for example, it is known to examine transparent or translucent objects by means of optical coherence spectroscopy (OCT). For example, U.S. Pat. No. 10,890,431 B2 discloses a VCSEL (vertical-cavity surface-emitting laser) OCT system for 3D measurement of transparent objects. In the known method, 3D depth profiles of an object are captured in scans using an optical coherence tomography system.

There is still room for improvement in the known systems and methods for optical coherence spectroscopy and optical characterization of transparent or translucent objects, in particular with regard to the type, size, structure of the objects to be measured, and the boundary conditions of the measurement or geometric characterization of the objects.

Proceeding from this, an improved or novel method for optical coherence spectroscopy, in particular for optically characterizing a transparent, semitransparent or translucent object, is to be provided. Furthermore, a corresponding optical coherence tomography system is to be provided.

This problem is solved in particular by the combinations of features of the independent claims. Advantageous embodiments result in particular from the dependent claims and the following description.

According to embodiments, a method for optically characterizing a transparent or semitransparent object is provided. Optically transparent should generally be understood in the sense of being translucent, and can therefore also comprise semitransparency or translucency, for example. In the strict sense, the term “optically transparent” in the context of the invention can mean transparency with respect to the infrared and/or visible spectrum. In particular, infrared-transparent objects should be included. Preferably, the method uses objects made of inorganic materials or non-biological materials.

The proposed optical characterization determines object dimensions, object distances and/or object positions based on optical coherence tomography (OCT for short). As already explained at the outset, OCT is a well-known method for characterizing objects based on coherent optical radiation.

Optical coherence spectroscopy is known per se. For example, with regard to optical characterization of objects by means of OCT, reference is made to “Cubic meter volume optical coherence tomography”, Fujimoto et al., vol. 3, no. 12/December 2016/Optica, and “Application of a long-range swept source optical coherence tomography based scheme for dimensional characterization of multilayer transparent objects”, Eneas N. Morel, Nélida A. Russo, Jorge R. Torga, Ricardo Duchowicz, Opt. Eng. 56 (8), 084102 (2017).

The method proposed herein is characterized in that a swept-source laser source, in particular a tunable laser source, preferably a wavelength-tunable laser source, is used as the light source, which has a coherence length in the decimeter to meter range. Furthermore, the proposed method is characterized by the fact that a reference substrate is used in the beam path of the light source, which reference substrate comprises a partially reflecting optical unit that is stationary in the beam path. The reference substrate is used to determine absolute distances and/or positions and/or dimensions of the object or to/from the object.

The underlying invention is based on the finding that the use of a swept-source light source with a reference substrate is suitable for characterizing at least partially transparent or translucent objects, in particular also moving objects, and provides comparatively reliable and accurate measurement results. In particular, at least partially transparent or translucent objects can be measured which, for example, perform a movement during the measurement and/or which emit non-negligible thermal radiation and/or which are arranged in the surroundings which emit non-negligible thermal radiation.

As mentioned, the proposed combination is suitable for measuring and/or characterizing hot objects, e.g., partially molten glass or objects made of glass. The method is particularly suitable for optically characterizing glass cylinders or cylindrical glass objects in or during manufacture, it being possible for the objects to be in an at least partially molten or not yet completely solidified state. For example, the proposed method makes it possible to determine the outer and/or inner diameters and/or wall thicknesses of objects.

In particular, the proposed method also provides an advantageous axial resolution since, in contrast to known methods, the proposed method works without Bragg gratings. The advantageous axial resolution results, for example, from the fact that the method proposed herein, in contrast to methods based on Bragg gratings, is substantially not limited or restricted with regard to the number of reference points or measurement points.

Furthermore, the proposed method allows for the measurement of both absolute and relative distances, thus allowing for improved optical characterization.

The proposed method also allows for the characterization of transparent or semitransparent objects substantially in real time, for example during the production or manufacturing process. In particular, the method is not limited to static objects, but rather allows for the characterization of moving objects.

According to embodiments, a swept-source laser source is used as the light source, which comprises a MEMS VCSEL-based light source (MEMS: micro-electro-mechanical system; VCSEL: vertical-cavity surface-emitting laser) or an akinetic light source. Such a light source particularly preferably has a coherence length in the range from 0.2 m to 100 m or more, or the coherence length of the emitted radiation can have a corresponding coherence length.

The proposed method with MEMS VCSEL light source and reference substrate is advantageously suited for comparatively large coherence length ranges and allows for particularly accurate coherence/interference measurements over substantially the entire range. Large coherence lengths can be used, for example, for larger distances between the measuring head or measuring apparatus and the object, for example when the object is a hot object, such as (partially) molten glass, and a certain distance to the object must be maintained due to the temperature.

According to embodiments, it can be provided that during signal acquisition and/or signal evaluation of the optical coherence tomography (OCT) signals:
a. k-clock resampling is used,
b. minima, maxima or zero crossings of the k-clock of the laser source are determined algorithmically and used them as a sampling clock, or
c. a k-clock hardware trigger or a k-clock hardware signal is used.

A k-clock allows data to be recorded linearly in time, which data can then be transformed into a linear sample in k-space. In particular, high-frequency signals can be evaluated more easily as a result. Furthermore, it is possible to characterize objects quasi in real time, which is advantageous, for example, for the geometric characterization of moving transparent or semitransparent objects during the manufacturing process.

A method by way of example according to b. for the algorithmic determination of minima, maxima or zero crossings of the k-clock can be as follows or comprise the following steps:
b1) normalization of the k-clock by division by the envelope;
b2) performing at least three, preferably immediately consecutive, mathematical operations, such as absolute value formation, addition, absolute value formation;
b3) smoothing, e.g. by a median filter or similar;
b4) peak finding or determination of maxima;
b5) interpolation of the maxima, minima and zero crossings to the linear k-space.

Due to the absolute value operation b2), minima, zero crossings and maxima of the k-clock can be determined using the proposed method steps by way of example.

According to embodiments, according to the method, in optical coherence spectroscopy the object can be scanned with laser light from the light source using a galvanometer scanner, or galvanoscanner for short, using a microlens array and/or a bifocal lens, preferably with a high numerical aperture. In particular, galvanoscanners, microlens arrays and bifocal lenses have proven suitable for the optical characterization of moving objects, for example during the manufacturing process. Such components are particularly suitable for measuring or characterizing partially or partly molten, moving transparent cylinders, e.g. made of glass.

With regard to the mode of operation of the galvanometer scanner, it is possible, for example, with moving objects, e.g., with rotating and axially moving objects, in particular with comparatively fast rotating and comparatively slow axially moving objects, that the galvanometer scanner is programmed in such a way that a point on the object or on the surface of the object, in particular a point or region targeted by the galvanometer scanner, rests in the reference system of the galvanometer scanner. The object can be, for example, a cylinder, an object with cylindrical geometry, or a cylindrical object. This is in particular possible within the context of the deflection achievable or available with the galvanometer scanner. When the galvanometer scanner reaches the end of its deflection or its deflection range, it is reset in terms of deflection and operated in such a way that it tracks or targets the next point on the surface.

Synchronization between the galvanometer scanner and data acquisition on the one hand and a rotation of the object on the other hand can be achieved, for example, by an angle sensor. In general, movements of the object, be it translation and/or rotation, can be detected by a sensor unit or sensor technology, and the detected movement data can be used for synchronization. Based on such data, for example a movement path of a point, in particular a targeted point or region, on the object, for example on the surface of the object, can be determined, and the galvanometer scanner and the data acquisition on the one hand and the movement of the object on the other hand can be synchronized based on the determined movement path. Preferably, the movement or a movement path is determined continuously, in particular in real time, and used for control and synchronization between the movement on the one hand and the galvanometer scanner and data acquisition on the other.

With regard to the functioning or operation of the microlens array, it can be provided that the light beam underlying the OCT is aligned along the direction of movement or along a movement path or a trajectory of a point of the object, in particular the object surface, and that the scanning takes place simultaneously at or for points or surface points of the trajectory. For example, if the movement or trajectory is known, the data acquisition and the movement can be synchronized, i.e., points on the object or on the object surface can be tracked with regard to the data acquisition.

When using a two-dimensional (2D) microlens array, it is in particular possible to scan the (immediate) vicinity of the trajectory, in particular the locations of interest on the object or a region around the trajectory. This scanning is particularly suitable for cylindrical objects or cylindrical-shaped objects.

The scanning by the microlens array preferably takes place in a stationary manner and further preferably at the repetition rate of the laser.

With regard to a bifocal lens or a sensor head with a bifocal lens, it should be mentioned that this can be used, for example, to optimize the signal strength reflected back from a sample or object. In particular, when the sample or object has, for example, (a) periodic fluctuations in the inner diameter (e.g., 50 mm over an axial range of 500 mm), e.g., when there is an axial tilt of the inner surfaces depending on the position of the object, and/or (b) a considerable stepwise change in the outer diameter across the axis or when measuring objects with a wide range of outer diameters (e.g. from 200 mm to 400 mm). For condition (a), a sensor head with a high numerical aperture is advantageously used, since the light reflected back from an inclined surface propagates at a considerable angle. In addition to the large aperture, it may be useful to separate the excitation of the sample from the detection of the back-reflected light so that collimated excitation is still possible. For condition (b), a sensor head with a bifocal lens is preferably used, which can map the focus of the front and back sides to the position of the receptive fiber end regardless of the diameter/size of the object. For these reasons, a dual-focus design is particularly advantageous for the conditions mentioned.

A bifocal lens or a double focus asphere can, for example, consist of two semi-convex lenses with focal points fa and fb that are connected to one another, the connecting surface running parallel to the axis of the, for example, cylindrical object. In another embodiment, a double focus asphere may be formed similarly to a zone plate with circular portions with alternating focal lengths fa, fb, fa, fb, etc., it being possible for this embodiment to be used substantially independently of the properties of the object to be examined.

Another variant of an optical setup with two focal points consists in using a single asphere, replicating identical receptive optical elements, e.g., fibers, (downstream of the asphere in the beam path) in an orthogonal arm and deflecting the incoming beam into both arms via a beam splitter. In this case, the focus of one receiving arm is preferably adjusted to the front, that of the other to the back of the object. The signal received by the elements or fibers is captured either by optical multiplexing or by means of an optical combiner.

If the dimensions of the object to be measured are (roughly) known in advance or substantially known, the lens distances of the dual-focus setup can be automatically adjusted to an optimal dual-focus configuration.

In embodiments, the probe arm or fiber and the receptive arm or receptive fiber may be formed by different elements or fibers. A collimated beam emerging from the probe fiber, for example, can be collinearly coupled into the receptive fiber with high numerical aperture via a microprism or a glass plate with polished end faces, which has, for example, a glued, angled, partially reflecting surface. This can prevent the light reflected back from the sample from being blocked.

In cases where an inclined surface of the object to be examined refracts the light beam at a small angle, so that a region on the opposite surface of the object is “excited” which is not exactly opposite with respect to the central axis of the object. This may lead to errors in determining the distance, dimension and/or position. In particular, in embodiments, it is possible to compensate for the deviation by placing an array camera or a plenoptic camera behind the sample, with which the direction or angle of the transmitted light can be recorded or determined. The direction or angle can be used to correct the distance, dimension and/or position, e.g., through ray tracing.

Depending on embodiments, a single-focus setup can also be used. In this case, it may happen that not all four reflections for the surfaces of the object can be recorded for all axial positions of the, for example, cylindrical object. In such cases, the position of the receptive fiber and/or the lens distances of the optical setup can be optimized so that at least three out of four reflections of the cylindrical object can be detected, allowing a continuous determination of, for example, inner diameter, outer diameter and wall thickness, for example after an initial 180° rotation.

Depending on the embodiments, as already mentioned, the object can be a moving object. When scanning the moving object, a scanning path used at least partially follows the movement of the object. Advantageously, in this embodiment, the data acquisition of the optical coherence tomography is synchronized with the scanning path.

In other words, the scanning path may move at least partially or in parts substantially synchronously with the movement of the object. In particular, it is a finding of the underlying invention that scanning moving objects based on the light source used, coherence length and the reference substrate allows for characterization, in particular measurement, of objects or parts thereof, even if the object is moving. As already mentioned above, in particular a galvanometer scanner and/or a microlens array can be used for scanning moving objects, whereby synchronization between the galvanometer scanner and/or microlens array and the data acquisition is or will be synchronized with the movement.

According to embodiments, it is provided that a spatial jitter is superimposed on the scanning path of the galvanometer scanner. In particular, such a jitter is not only advantageous for irregularly shaped objects, but further supports data acquisition for moving objects. The jitter can be generated, for example, by suitable control of the galvanometer scanner. If the object surface is ideally perpendicular to the OCT light beam, a jitter is not necessarily required. Since real objects, in particular objects undergoing a manufacturing process, fluctuate with regard to the orientation of the surface(s), the use of a jitter can improve the accuracy and/or reliability of the acquired object data. In other words, a jitter makes it possible, for example, to obtain a back reflection or reflection rays from the object, at least to a certain extent, even if the object surface is irregular. A jitter can be adjusted, for example, by superimposing a deflection or movement that is orthogonal to the trajectory of the point on the object onto the movement of the galvanometer scanner according to the trajectory of the point.

According to embodiments, the method combines several, in particular a plurality of, reflection profiles (or: A-scans) obtained along the scanning path, in particular to form a combined reflection profile. Periodogram signals can be determined from the combined reflection profile thus obtained, and at least one object dimension, an object distance and/or an object position can then be determined from at least one periodogram signal, i.e., from one or more periodogram signals.

In particular, distances between boundary surfaces of the object and/or their position or location with respect to one another relative to a precisely known reference, formed, for example, by the stationary partially reflecting optical unit, can be determined.

It is therefore possible to determine object dimensions, distances and positions comparatively accurately and reliably, in particular also when the object is moving and/or when the object structure or geometry varies within certain limits.

According to embodiments, for example, those A-scans can be filtered out which have a number of back reflections expected from the geometry of the object to be examined, e.g., flat, cylindrical, etc. The expected number of back reflections in OCT can be determined or derived, for example, from the (rough) geometry, target geometry and/or expected geometry of the object to be examined. The rough, target and/or expected geometry can be provided to the method, e.g., a corresponding evaluation unit, as a parameter or parameter data set, e.g., as an input parameter or data set, in particular an input parameter data set.

With regard to the selection of the A-scans to be used or usable for the optical characterization, it is also or additionally possible to use, e.g., filter out, those A-scans which, for example from a group or set of recorded A-scans, show or have a maximum intensity and/or which have the best S/N (signal-to-noise ratio).

In this case, a periodogram is understood in the usual sense, in particular as a distance signature of the reflections caused by the boundary surfaces of the object, distance signature for short.

According to embodiments, it can be provided that an infrared filter, preferably a dual-band mirror, is arranged in the beam path of the light source, and thermal radiation emanating from the object and/or the object surroundings in the range of the far infrared spectrum is at least predominantly filtered out using the infrared filter. The infrared filter is preferably placed in the beam path upstream of a measuring head used to detect the light reflected from the object. In particular, it is possible to prevent radiation or extraneous radiation in the infrared spectral range of thermal radiation interfering with measured values, or to improve the S/N ratio for the light reflected from or on the object. The use of an infrared filter is advantageous, for example, in the characterization of hot objects or objects which themselves and/or the surroundings of which emit radiation in the infrared spectral range of thermal radiation, at least to an extent that would or does lead to an impairment of the measured values for the light reflected from the object by the OCT. With regard to infrared radiation, a spectral range in particular comes into consideration which, assuming a black body radiator, corresponds to a temperature range from 800 K to 2200 K.

According to embodiments, it can be provided that the optical coherence tomography comprises a signal recording of the k-clock of the light source with a software-based filtering and an offset correction, and furthermore, optionally, comprises a subsequent phase extraction, in particular based on a Hilbert transformation, and/or an evaluation of zero crossings and extrema. The filtering can preferably be low-pass filtering.

Based on the signal recording of the k-clock, linearization in time is possible, which in particular allows for real-time characterization of objects. By means of a subsequent phase interpolation, i.e., a phase interpolation of the phase profile of the measurement signals, the data or measurement signals recorded linearly in time due to the k-clock used can be transformed into a linear sampling in k-space. This can increase the resolution of the method or of a system executing the method.

Depending on embodiments, an extraction of the phase profile and a reinterpolation of the data based on this phase profile can be carried out for each individual sweep of the swept-source laser. This can, for example, ensure that the system, in particular the signal evaluation and/or processing, is robust with regard to fluctuations in the phase profile of the laser.

According to embodiments, filtering, in particular low-pass filtering and/or phase interpolation, can be carried out after each individual sweep of the laser. For example, a 10 KHz laser has a frequency of 10 KHz. Particularly advantageous for processing and/or handling the measurement signals at such frequencies is an implementation on an architecture with parallel data processing, for example on graphics processing units (GPU). For example, in applications the sampling rate of the digitizer can result in a laser repetition rate of 10 kHz to 100 KHz and, depending on the laser duty cycle, comparatively high data rates in the range from 5 to 7 GB/s (gigabytes per second) can arise, which cannot be handled satisfactorily or at all with a conventional CPU. Advantageously, the processing and/or handling of the measurement signals is therefore carried out on a GPU, which can be implemented, for example, in CUDA (compute unified device architecture).

Examples of filters are bandpass filters, median filters, etc. Examples of interpolations are polynomial interpolation, Chebyshev interpolation, and the like.

According to embodiments, it is provided that periodogram signals are determined from signals of the optical coherence tomography by means of an automatic peak-picking algorithm from periodogram data, and that at least one object dimension, at least one object distance and/or at least one object position are/is determined from the periodogram signals, in particular taking into account periodogram signals of the reference substrate.

In this case, the term “peak picking” (or peak finding) should be understood in the sense of the prior art as, for example, an algorithm with which local maxima or minima can be determined from signals, in particular measurement signals and/or processed measurement signals. Such an algorithm may, for example, comprise a determination of zero crossings of the numerical first derivative of the signal(s), zero crossings being associated with individual peaks, in particular local maxima or minima.

In the peak-picking algorithm, in particular data relating to the (rough) geometry and/or target geometry and/or expected geometry of the object can be used as input parameters or boundary conditions. Particularly when manufacturing objects, for example glass objects such as glass cylinders, the geometry of the object or a desired geometry of the object is known or specified. If, in the case of a cylindrical object to be manufactured, for example the target diameter, for example the inner and/or outer diameter and/or the wall thickness of the object, is known or specified, then these data provide at least approximately the location(s) or position(s) of the signals to be expected, which can be calculated or determined, for example, taking the measuring arrangement into account. For example, if a cylindrical object is measured with approximately radially incident light, reflection signals, i.e., peaks, for reflections on the outer and inner surfaces of the cylindrical object walls are to be expected.

Based on the measurement signals and specification data on the geometry of the object and/or the measurement setup, it is possible to monitor a manufacturing process, i.e., to characterize the object during manufacture, in particular with regard to whether the manufactured object meets the underlying requirements regarding geometry and/or dimensions. Therefore, quality control and/or control of a manufacturing process is possible. Furthermore, for example, a correlation of deviations in the object geometry with operating parameters of the production plant and/or, based on deviations in the object geometry, a fault analysis for the production plant, can also be provided.

The advantage of the proposed method is in particular also that real-time characterization is possible, which allows a production process to be optimized and/or the quality of the manufactured products to be characterized already during manufacture. Complex object characterization after manufacture can be omitted.

In particular, the stationary, partially reflecting optical unit proposed herein makes it possible to determine not only relative object distances or object dimensions based on the measurement signals, in particular peaks, but also (absolute) distances, dimensions and/or positions based on the measuring system or the optical measuring system used.

By way of example, and according to concrete measurements carried out, the proposed method can be used in particular to characterize cylindrical, transparent or semitransparent objects, such as cylinders, for example glass cylinders, which have, for example, a diameter of 50 mm to 700 mm and a wall thickness of 0.05 mm to 100 mm. It turns out that the proposed method is suitable for a comparatively broad range of applications.

According to embodiments, an optical coherence tomography system is provided which is designed for optically characterizing a transparent or semitransparent object based on optical coherence tomography (OCT). The coherence tomography system comprises at least one swept-source laser source with a coherence length in the range from 0.2 m to 100 m or more, in particular in the meter range, a reference substrate arranged in the beam path of the at least one light source, which reference substrate comprises, for example, a partially reflective optical unit that is stationary in the beam path, and a control unit with a processing unit, in particular a processing unit with an architecture for parallel data processing, such as a graphics processing unit, and a memory associated with the processing unit, which memory comprises instructions that, when executed by the processing unit, effect a method according to one of the method-related embodiments proposed herein. For the purposes of this invention, a processing unit with associated memory, designed to carry out a method according to any of the embodiments proposed herein, is generally understood to mean an electronic unit which is programmed and/or designed such that, during operation, it executes a method according to any of the embodiments proposed herein.

Advantages and advantageous effects of the coherence tomography system and its design arise in particular from the advantages and advantageous effects of the embodiments according to the method. Reference is made in this respect and in particular to the above statements.

According to one embodiment of the optical coherence tomography system, the swept-source laser source is or comprises a MEMS VCSEL-based light source or an akinetic laser light source, and/or a coherence length of the light source is in the range from 0.2 m to 100 m or more.

According to one embodiment of the optical coherence tomography system, it furthermore comprises at least one galvanometer scanner designed to scan the object and/or at least one microlens array designed to scan the object. In particular, these components allows for precise scanning of an object to be characterized, in particular also when the object is moving, for example when the object moves along a movement path during manufacture.

Usually, the or a corresponding movement path of the object is known or predetermined. The predetermined or known movement path can be used, for example, for controlling the galvanometer scanner and/or for signal evaluation of the data acquired via the microlens array.

Within the scope of the invention, it is possible or provided in embodiments to detect or determine the movement of the object, a linear movement and/or the rotational movement, or the movement path of the object, and thus at least indirectly the movement path of the object region or point to be measured in each case. For this purpose, for example a sensor or measuring system can be provided that is set up to detect the movement of the object.

According to embodiments of the optical coherence tomography system, this furthermore comprises at least one infrared filter arranged in the beam path of the light source, preferably a dual-band mirror, which is designed to at least predominantly filter out thermal radiation emanating from the object and/or the object surroundings in the range of the far infrared spectrum. Such a coherence tomography system is suitable in particular for characterizing hot objects, which emit thermal radiation that cannot be ignored with regard to OCT or that impairs the result of the OCT. Such an infrared filter also makes it possible to measure or characterize objects in surroundings that emit thermal radiation that cannot be ignored with regard to OCT or that impairs the result of the OCT.

According to embodiments of the optical coherence tomography system, the light source has a bandwidth in the range from 20 nm to 100 nm, and/or of at least 40 nm.

According to embodiments of the optical coherence tomography system, the light source is designed for repetition rates in the range from 4 kHz to 4 MHz, in particular for repetition rates of approximately 10 KHz.

According to embodiments, an optical coherence tomography system is provided, which can be designed in particular according to any of the embodiments described above. The optical coherence tomography system may comprise a k-clock unit, or a k-clock for short, for generating a k-clock signal for signal acquisition and/or signal evaluation for optical coherence tomography, in particular for k-clock-based resampling. The k-clock unit comprises a Fabry-Pérot interferometer, i.e., an interferometer constructed in the manner of a Fabry-Pérot interferometer, which can also be referred to as a k-clock interferometer, or more precisely a k-clock Fabry-Pérot interferometer. In this context, it can be provided in the above-described embodiments according to the method that a k-clock interferometer is used which has the described structure and generates k-clock signals in the manner described here. The embodiments of the k-clock unit described here apply accordingly for the embodiments according to the method, in particular for generating k-clock signals.

The Fabry-Pérot interferometer or k-clock interferometer is designed or intended to generate interferometry signals based on laser radiation from the swept-source laser source, which is fed to the Fabry-Pérot interferometer or with which it is fed. In this case, the term “feed” is intended to mean that laser light from the laser source is coupled into the Fabry-Pérot interferometer, for example via optical conductors or light guides.

The Fabry-Pérot interferometer comprises a first mirror, a second mirror and a spacer. The mirrors are attached to or connected to sides of the spacer facing away from one another. The spacer ensures that the mirrors are attached or arranged spaced apart from one another, with the distance being defined by the length of the spacer. In this case, mirror surfaces of the mirrors face the spacer and are aligned plane-parallel to one another. Advantageously, the first and second mirrors are wedge-shaped, the mirrors being wedge-shaped in particular with respect to planes perpendicular to the optical axis of the Fabry-Pérot interferometer. In this case, the optical axis is an axis running perpendicular to the plane-parallel mirror surfaces. According to the findings of the invention, a Fabry-Pérot interferometer is particularly well suited for generating stable, in particular temperature-stable, k-clock signals, in particular for the application underlying the invention of characterizing transparent or semitransparent objects.

Particularly preferably, the mirrors have an anti-reflective layer or coating which prevents the mirrors from acting as such in the sense of an etalon or etalonizing.

The Fabry-Pérot interferometer is therefore advantageously designed as a planar surface interferometer.

For fastening the mirrors to opposite sides, in particular flat surfaces or plane-parallel sides, of the spacer, retaining elements, in particular retaining rings, can be provided which press the mirrors onto the spacer without stress.

The optical path length of the Fabry-Pérot interferometer between the mirrors is preferably defined by the axial length of the spacer, the axial length extending perpendicularly to the plane-parallel mirror surfaces. End surfaces of the spacer on which the mirrors are positioned are preferably highly parallel, for example with a parallelism of less than 0.005 degrees. With such parallelisms, an, in particular, suitable quality or finesse can be obtained for generating k-clock signals for optical coherence tomography.

According to embodiments, the spacer may be made of or consist of a material having an ultra-low or negligible thermal expansion coefficient or temperature coefficient of expansion. In particular, the spacer should consist of or be manufactured from a material for which temperature-related changes in the length of the spacer and associated changes in the distance between the mirrors are negligible in the case of temperature changes in the operating temperature range or operative temperature range of the interferometer relevant for the application intended herein, e.g., ambient temperature, for example 15° C. to 30° C. Preferably, the spacer should be made of or consist of a material for which temperature-related changes in length of the spacer in the respective operative temperature range, in particular perpendicular to the mirror surfaces, are negligible in relation to the wavelengths of the laser light from the swept-source laser source. Corresponding materials preferably have a thermal expansion coefficient in the range from −2*10⁻⁷/K to +2*10⁻⁷/K. Examples of materials are glass materials, such as glass ceramics with extremely low thermal expansion coefficients (so-called “ultra-low expansion glass materials”), in particular ULE® ultra low expansion glass (Corning Inc., Corning, N.Y.), or Zerodur® glass-ceramic (Schott AG, Mainz, Germany).

Preferably, the materials can be processed, in particular also processed or manufactured in hollow cylindrical form, in such a way that for plane-parallel bearing surfaces of the mirrors on the end faces of the spacer, in the case of a hollow cylindrical form on the respective end faces of the hollow cylinder, an angular error of 0.002° to 0.005° or less can be implemented.

According to embodiments, the spacer is hollow-cylindrical and forms a hollow-cylindrical gap or air gap between the mirror surfaces, which is delimited, for example, circumferentially by the outer wall of the spacer. The gap or air gap can be sealed in the region of the contact surface or bearing surface between the mirrors and the spacer, i.e., in the region in which the mirrors are positioned on the spacer or abut or contact it, by anodic bonding or anodic joining, by optical contact bonding or by cementing. By such measures, the gap or air gap, or vacuum gap, can be sealed against the outside atmosphere to avoid interference.

According to embodiments, a beam splitter connected to the light source on the one hand and to the k-clock unit on the other hand can be provided for feeding the k-clock unit, in particular the Fabry-Pérot interferometer, with laser light from the light source, wherein the beam splitter is preferably designed to feed the k-clock unit via an input associated with the first mirror with a proportion of the laser light from the light source in the range of 0.5% to 2%, in particular of approximately 1%. The remaining laser light, e.g., 99% or a corresponding residual portion, can be fed to the sensor head or the sensor unit or scanning unit of the optical coherence tomography system, for example for recording or executing the A-scan signals (so-called A-scans).

According to embodiments, the optical coherence tomography system, in particular the k-clock unit, can comprise a detector, in particular a high-speed detector, with at least one input which is light-optically coupled to an output associated with the second mirror of the k-clock unit, in particular of the Fabry-Pérot interferometer, for detecting interferometry signals of the Fabry-Pérot interferometer. In this case, the second mirror is preferably designed as a transparent mirror or a semitransparent mirror, so that the interferometry signals can be coupled out at the second mirror and fed to the detector.

According to embodiments, the optical coherence tomography system, in particular the k-clock unit, may further comprise a data processing unit which is designed to evaluate detected interferometry signals, i.e., to evaluate detection signals of the detector, and to generate a k-clock signal based on the evaluation of the detected interferometry signals. Thus, the data processing unit can be designed to generate the k-clock signals based on the interferometry signals of the k-clock interferometer, the k-clock signals being provided, for example, for carrying out a k-clock-based resampling. This k-clock-based resampling can also be understood as k-space linearization of the OCT signal based on the k-clock signal.

According to embodiments of the optical coherence tomography system, the detector can be implemented as a balanced detector or symmetric detector for the purpose of improving the signal-to-noise ratio and suppressing interference signals. The balanced detector may have two inputs, a first detector input being light-optically coupled to an output of the Fabry-Pérot interferometer or k-clock interferometer associated with the first mirror, and a second detector input being light-optically coupled to an output of the Fabry-Pérot interferometer associated with the second mirror. In this case, the mirrors are preferably each designed as transparent mirrors or semitransparent mirrors.

According to embodiments, the optical coherence tomography system may further comprise a circulator with three ports or terminals or terminal interfaces, the laser light source being light-optically coupled to a first port for feeding the Fabry-Pérot interferometer with laser light from the laser light source (for example 0.5-2%, in particular 1% of the laser light) via a second port of the circulator connected to an input associated with the first mirror. The second detector input of the detector is light-optically coupled to a third port of the circulator, and the circulator is designed such that interferometry signals of the Fabry-Pérot interferometer emitted to the second port via an output of the Fabry-Pérot interferometer associated with the first mirror are directed via the third port of the circulator to the first terminal of the detector.

Particularly preferably, the amplitudes of the signals supplied to the first and second terminal of the detector are adapted to one another before being supplied to the detector. For this purpose, inline fiber attenuators or attenuators are suitable, for example, which are connected and/or integrated in the light-optical paths, for example in light-guiding elements such as optical fibers, between the k-clock unit and the detector.

The light-optical coupling of the above-mentioned components, such as laser light source, beam splitter, circulator, k-clock interferometer, detector, etc., can be achieved in particular via light guides or optical fibers or optical fiber bundles. Preferably, the optical path lengths of the light-optical connections between the terminals of the detector and the k-clock interferometer are of equal length. This means that the light-optical connections connecting the output on the first mirror to the first terminal of the detector and the output on the second mirror to the second terminal of the detector have the same optical path lengths.

With the proposed k-clock unit, the measurement accuracy of the swept-source OCT system proposed herein, in particular of the swept-source OCT sensor system, can be improved, in particular optimized. Thus, the measurement accuracy, in particular for the intended application, depends on the stability of the k-clock or the k-clock unit, which in embodiments as described above comprises or forms an interferometric device and measures the wavelength sweep of the sweep-source laser light source or laser. In particular, the proposed k-clock unit can ensure that the free-spectral range (FSR) of the k-clock unit is constant and independent of environmental influences such as temperature or pressure fluctuations. The FSR is related to the optical path length differences of the k-clock unit, in particular the k-clock interferometer. The proposed design and use of the k-clock unit make it possible to minimize corresponding environmental influences and to obtain an FSR with which sufficiently accurate measurements can be carried out, in particular for the application envisaged herein.

Compared to known methods for optically characterizing transparent or semitransparent objects by means of OCT, the proposed method and the OCT system according to the embodiments described herein can implement comparatively large axial ranges, i.e., ranges measured parallel to the light radiation, in particular for objects with diameters of up to 100 mm and more, for example with diameters of up to 700 mm and more.

Furthermore, in embodiments, the proposed method makes it possible to characterize moving objects, for example during a manufacturing process in which the object is moved, for example performing a rotational and/or translational movement. An example of this is the manufacture of cylindrical bodies or objects made of glass.

Embodiments of the proposed method and a corresponding optical coherence tomography system particularly and advantageously allow for optical characterization by means of OCT of hot objects, i.e., objects that emit comparatively strong blackbody radiation, i.e., thermal radiation. Examples include the manufacture of objects or bodies from molten glass, or more generally based on hot forming. In particular, it is possible to monitor or characterize objects and object geometries during hot forming during manufacturing, which makes it possible to adapt and monitor process conditions for manufacturing in real time and/or to reduce waste. Characterization steps that would otherwise normally be required after manufacture can also be omitted, which simplifies and, in particular, shortens the manufacturing process.

In embodiments, the proposed method and optical coherence tomography system enable, in particular in contrast to known methods and devices, the measurement or determination of absolute and relative distances. In particular, it is not necessary to provide separate devices for determining relative distances on the one hand and absolute distances on the other. Absolute distances can, for example, be relevant for the question or characterization of the manufacturing process if the object or product is to move according to a predetermined path, e.g., in a straight line, during manufacture.

By determining absolute distances, for example deviations from the path can be detected and the manufacturing process can be adjusted, or potential sources of error or malfunctions in the manufacturing process or production plant can be identified from deviation data.

Relative distances can, for example, be used to characterize the geometry of the object itself, such as diameter, wall thickness, cross-sectional shape, etc.

The proposed method and optical coherence tomography system are in particular flexibly usable and suitable for a comparatively broad range of applications. For example, the method is suitable for measurements with a comparatively large axial depth and simultaneously high resolution (e.g., 10 micrometers) and/or with a comparatively small axial depth and simultaneously very high resolution (e.g., 1 micrometer).

Compared to the known methods and devices, an advantageous resolution can be achieved in embodiments with the proposed method, in particular with the algorithms proposed herein for processing OCT signals. In particular, OCT signals or signals derived therefrom with advantageous half-width can be achieved.

Embodiments of the invention are described below with reference to the accompanying drawings, in which:

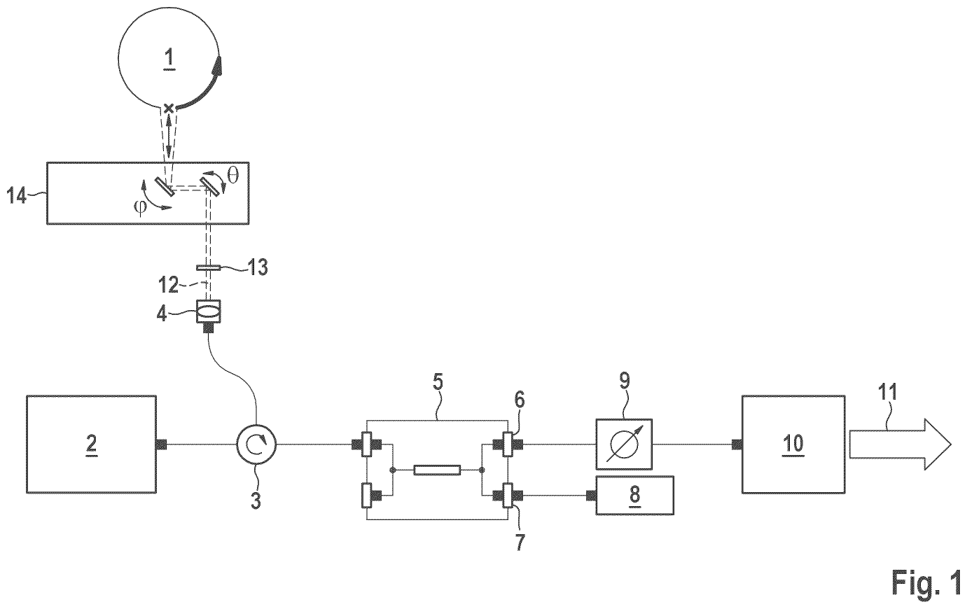

FIG. 1 schematically shows a first device-based OCT implementation for characterizing an object;

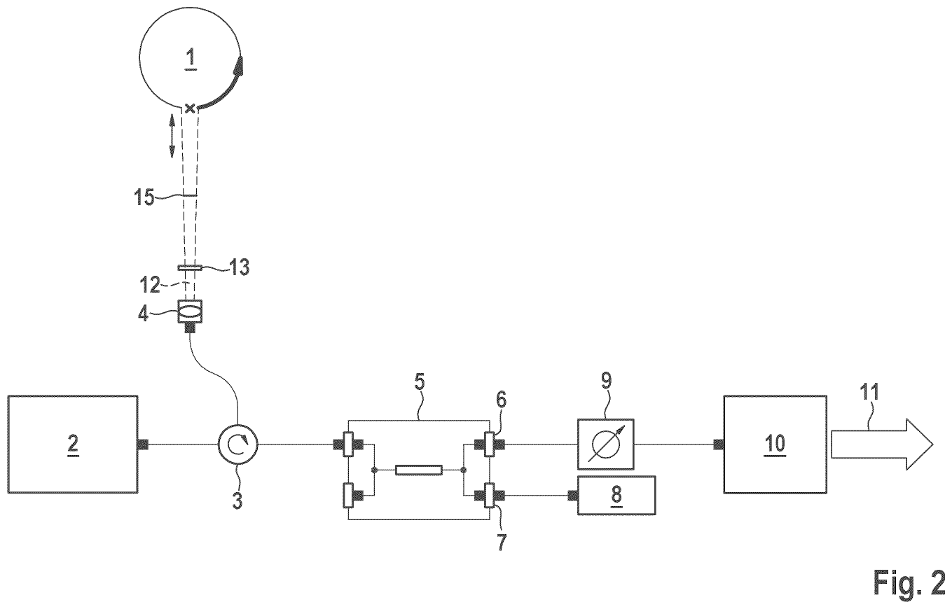

FIG. 2 schematically shows a second device-based OCT implementation for characterizing an object;

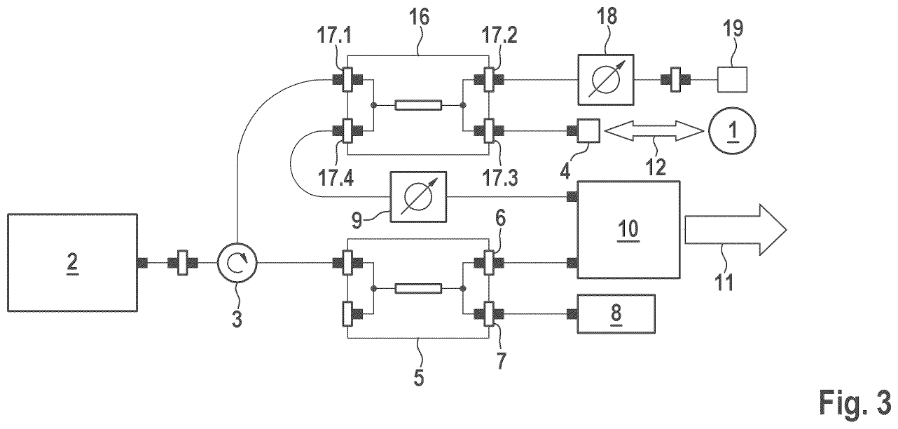

FIG. 3 schematically shows a third device-based OCT implementation for characterizing an object;

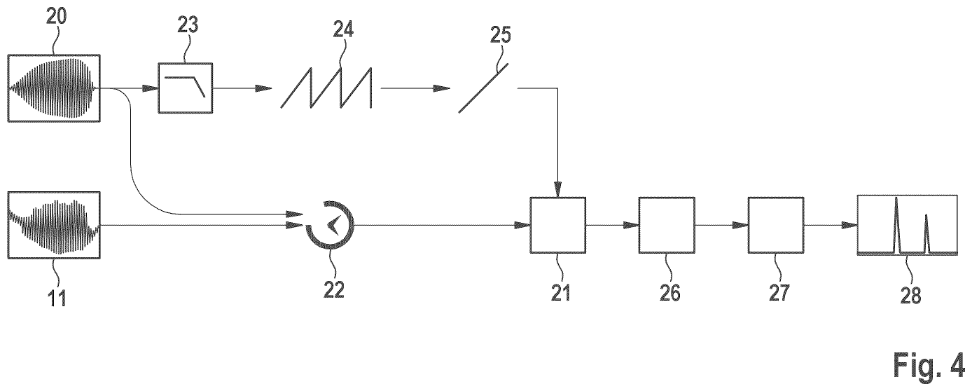

FIG. 4 shows a course of the method for determining periodograms;

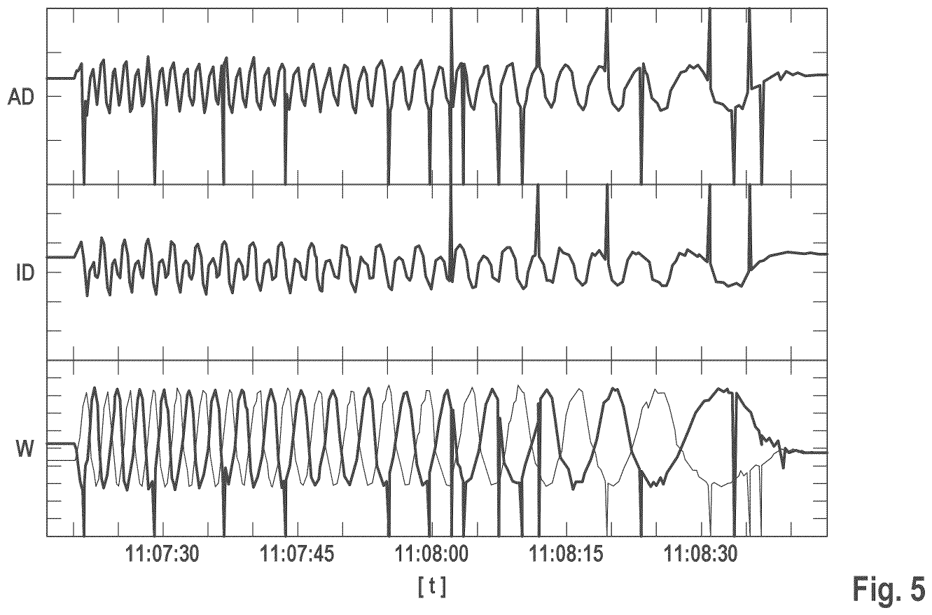

FIG. 5 shows OCT measurement results by way of example for the characterization of a glass cylinder based on the third implementation;

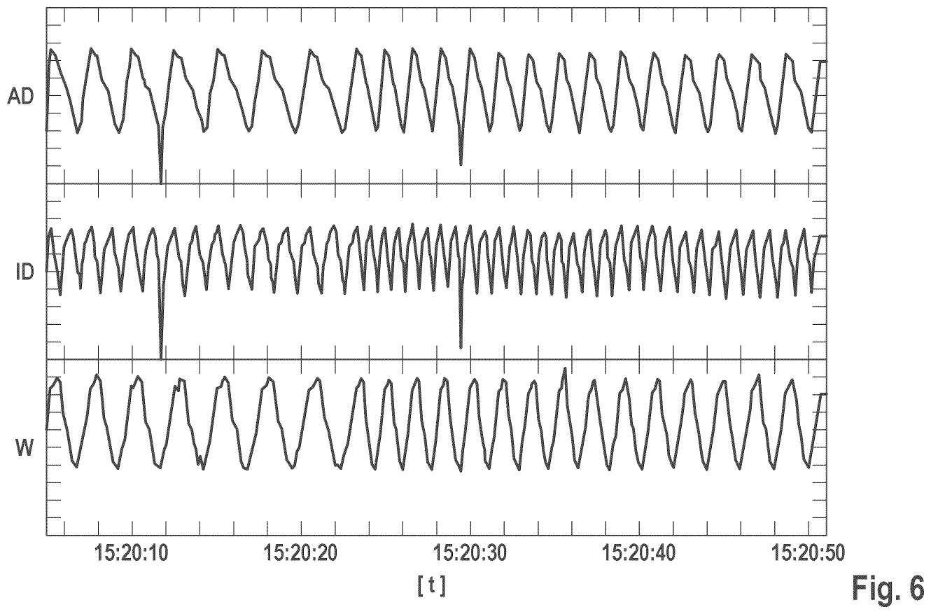

FIG. 6 shows OCT measurement results by way of example for the characterization of a glass cylinder based on the first or second implementation;

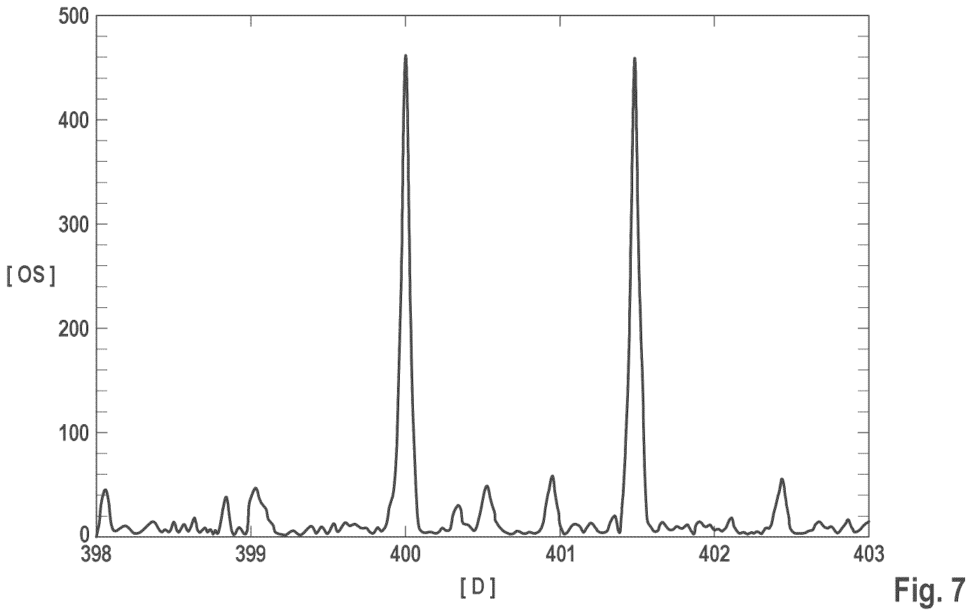

FIG. 7 is a graph by way of example for the characterization of a glass cylinder with a comparatively large axial depth;

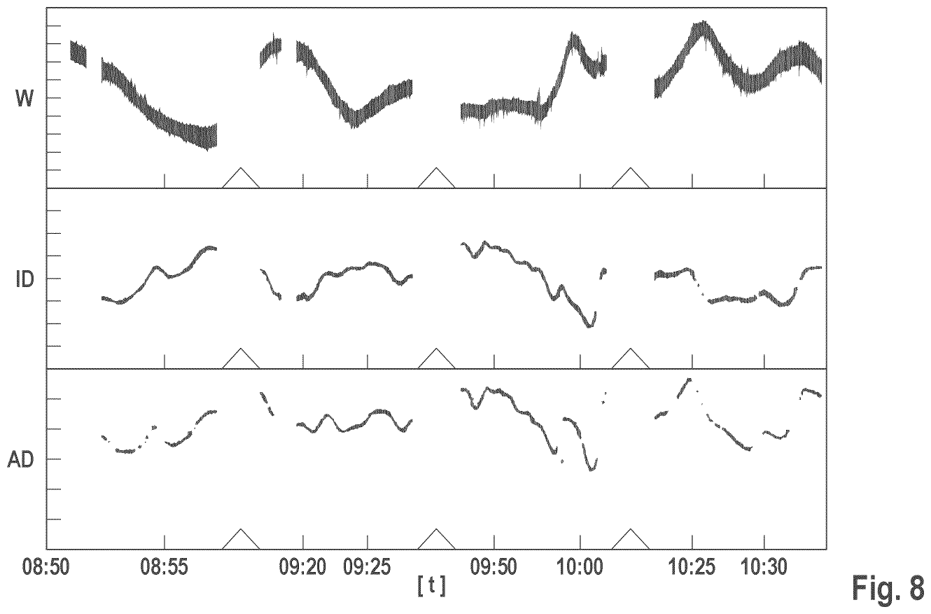

FIG. 8 shows OCT measurement results by way of example for the characterization of a moving, hot glass cylinder;

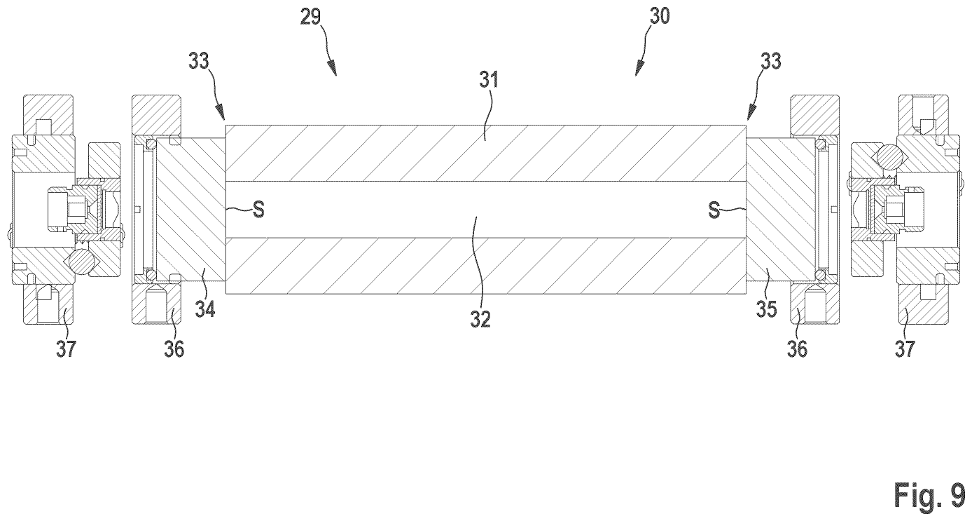

FIG. 9 shows a structure by way of example of a k-clock interferometer;

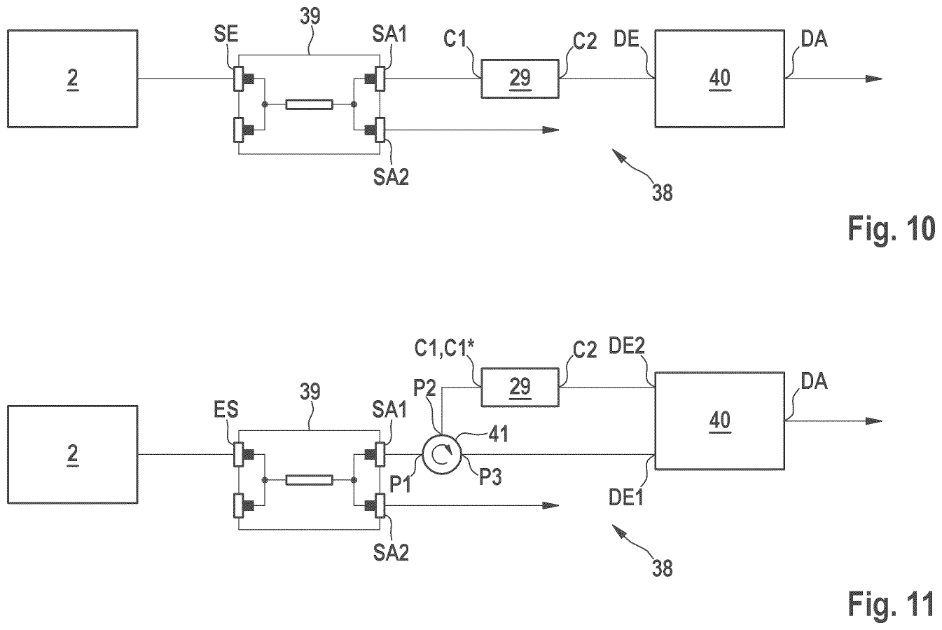

FIG. 10 shows, by way of example, a first implementation of a k-clock unit with a k-clock interferometer according to FIG. 9; and

FIG. 11 shows, by way of example, a second implementation of a k-clock unit with a k-clock interferometer according to FIG. 9.

Identical or functionally identical elements are designated by the same reference signs in the figures. The figures merely describe applications or implementations by way of example, without the invention being limited thereto or to the advantages or advantageous effects resulting therefrom.

FIG. 1 schematically shows a first device-based OCT implementation for characterizing an object 1, which may be, for example, a glass hollow cylinder, for short also glass cylinder or cylinder.

The device-based implementation comprises a swept-source laser 2, also referred to as laser 2 for short, followed by a circulator 3. The three terminals of the circulator 3 are connected to the laser 2, a collimator 4 and a beam splitter 5. The beam splitter 5 can have a splitting ratio of 90:10, with a first output 6 being associated with the splitting ratio 90 and a second output 7 being associated with the splitting ratio 10.

A power monitoring unit 8 is connected downstream of the second output 7.

The first output 6 is followed by a variable optical attenuator 9 (VOA), which is followed by a high-speed detector 10 for generating OCT signals 11.

Laser light guides, in particular so-called TEC fibers (TEC: thermally extended core), can be used to connect the components.

Stationary, a partially reflecting optical unit 13 or a stationary reference substrate 13 is connected downstream of the collimator 4 in the beam path of the laser radiation 12 coming from the laser 2. Downstream of the reference substrate 13 in the beam path of the laser radiation 12 coming from the laser 2 there is a galvanometer scanner 14, for short also scanner 14, for beam deflection with deflection angles φ (phi) and θ (theta). The object 1 to be measured or characterized is arranged downstream of the scanner 14 in the beam path.

During operation for measuring or characterizing the object 1, the laser radiation 12 emanating from the collimator 4 first passes through the reference substrate 13 and then strikes the scanner 14, which directs the laser radiation 12 onto the object 1. Laser radiation 12 reflected from the object 1 passes via the scanner 14, the collimator 4 and the circulator 3 to the beam splitter 5, which directs the reflected laser radiation 12 or its signals via the first output 6 via the variable optical attenuator 9 to the detector 10. The detector 10 generates OCT signals from the reflected laser radiation 12 or from corresponding signals, for the optical characterization of the object 1.

Based on the scanner 14, or by appropriate control of the scanner 14, for example the angle φ (phi) and/or θ (theta), the laser radiation 12 can be directed or radiated onto the object 1 in such a way that the point of impact x of the laser radiation 12 on the object 1 follows, for example, a movement of the object 1. In the example shown, the object 1 performs a counterclockwise rotation, which is indicated by a curved arrow. If the object 1 moves linearly at the same time, for example from the figure plane of FIG. 1, by appropriate control of the scanner 14 also makes it possible to achieve that the point of impact x further follows this linear movement. Therefore, moving objects can be optically characterized by means of OCT.

FIG. 2 schematically shows a second device-based OCT implementation for characterizing an object. In contrast to the implementation according to FIG. 1, here a microlens array 15 is connected downstream of the collimator 4 and the reference substrate, through which the laser radiation 12 is directed onto the object 1. The microlens array 15, for example a 2D microlens array, also makes it possible to track points x on the object 1 or on the object surface, so that the second implementation also makes it possible to characterize objects 1 which exhibit a rotational movement and/or a translational movement (e.g. according to a movement out of the figure plane of FIG. 2). Apart from 2D microlens arrays 15, 1D microlens arrays 15 can also be used.

In further implementation variants, a galvanometer scanner 14 and a microlens array 15 can be used in combination.

Otherwise, the structure of the implementation according to FIG. 2 corresponds to that shown in FIG. 1.

The implementations according to FIG. 1 and FIG. 2 correspond to a setup with autocorrelation. FIG. 3 schematically shows a third device-based OCT implementation for characterizing an object 1, this implementation corresponding to a setup with cross-correlation.

In the case of the setup shown in FIG. 3, analogously to FIG. 1 and FIG. 2 a beam splitter 5 is present, which is connected on the one hand to a circulator 3 and on the other hand to a high-speed detector 10 or a power monitoring unit 8. In contrast to FIGS. 1 and 2, the terminal of the circulator 3 closest to the terminal of the laser 2 in the circulation direction of the circulator 3 is connected to a first terminal 17.1 of a further beam splitter 16. A second terminal 17.2 of the further beam splitter 16 is connected to a furthermore variable optical attenuator 18 and a retroreflector 19. A third terminal 17.3 is connected to a collimator 4, which is designed as in FIG. 1 and FIG. 2 to collimate laser radiation 12 onto the object 1 to be measured or characterized or laser radiation 12 reflected from the object 1. A fourth terminal 17.4 is connected to the detector 10 via a variable optical attenuator 9. In the implementation according to FIG. 3 with cross-correlation, the detector 10 is therefore coupled to both beam splitters 5, 16 for receiving laser signals. A reference substrate 13 and microlens array 15 are not shown in FIG. 3, but may be present individually or in combination.

FIG. 4 shows a course of the method, by way of example, for determining periodograms. The algorithm uses a k-clock 20 based resampling 21 for the OCT signals 11. For performance reasons, the algorithm is executed on a processing unit architecture with parallel data processing, such as a GPU.

For resampling 21, the start times for k-clock and OCT signals are adjusted or aligned 22. Before resampling, the k-clock is filtered 23 with a zero-phase low-pass filter, followed by a calculation 24 of the phase evolution and an extraction 25 of the phase profile (so-called “phase unwrapping”). After the k-clock-based resampling 21 of the OCT signals, a fast Fourier transform (FFT) 27 is applied to the resampling result, after a window function is applied 26, to determine OCT periodograms 28. From the OCT periodograms 28, in turn geometric parameters or variables characterizing the object 1 can be determined, such as diameter, wall thickness, etc.

For measuring or characterizing moving objects 1, which, for example, perform a comparatively fast rotational movement superimposed with a comparatively slow translational movement, the mirrors of the galvanometer scanner 14 are synchronized with the data acquisition in such a way that a point on the surface of the moving object 1, for example a cylinder, is tracked in space. If necessary, a certain spatial jitter can be added to the mirrors of the galvanometer scanner 14, in particular to compensate for any non-perpendicular orientation of the surface of the object 1 relative to the incident laser beam.

Tracking the point in space and the spatial jitter contribute in particular to reducing the probability of signal loss or substantially avoiding signal losses. Signal losses would, for example, lead to an incomplete characterization of the geometry of the moving object 1.

All A-scan signals obtained from tracking the point in space are combined and used to calculate periodogram signals. By combining the A-signals, robustness against signal losses can be achieved.

For example, an automatic peak-picking algorithm can be used to identify maxima of the OCT periodograms 28.

FIG. 5 shows OCT measurement results by way of example for the characterization of a glass cylinder based on the third implementation (“cross-correlation”). In the graph of FIG. 5, the abscissa (x-axis) denotes the time t and on the ordinate (y-axis) the wall thickness W, inner diameter ID and outer diameter AD are each given in arbitrary units, e.g., in mm. The OCT measurement uses a rotating glass cylinder as the object 1 to be measured. The graph shows the course or the determined values for wall thickness W, the inner diameter and the outer diameter AD over time from the OCT measurement, which in turn is linked to the movement of the glass cylinder.

FIG. 6 shows OCT measurement results by way of example for the characterization of the glass cylinder according to FIG. 5 based on the first or second implementation (“autocorrelation”). In the graph of FIG. 6, analogously to FIG. 5, the abscissa (x-axis) represents time t and the ordinate (y-axis) also shows wall thickness W, inner diameter ID and outer diameter AD, each in any unit, e.g., in mm.

FIG. 7 shows a graph by way of example for characterizing a glass cylinder as the object 1 used, at a comparatively large axial depth, in particular at a comparatively large distance between the object 1 and the measuring device. In the example shown, this is approximately 400 mm. In the graph of FIG. 7, the abscissa (x-axis) denotes the distance D of the object 1 from the measuring device in millimeters (mm) and the ordinate (y-axis) denotes the OCT signal strength OS (in arbitrary units). As can be seen from the graph, signals with a low signal-to-noise ratio can be obtained even at comparatively large distances. Furthermore, it can be seen that, for example by using the reference substrate 13, absolute distances can also be determined.

FIG. 8 shows OCT measurement results by way of example for the characterization of a moving, hot glass cylinder. An infrared filter was used in the measurement, which is designed to filter out thermal radiation, emanating from the object and/or the object surroundings, in the range of the far infrared spectrum. In the graph of FIG. 8 the abscissa (x-axis) denotes the time t and on the ordinate (y-axis) the wall thickness W, inner diameter ID and outer diameter AD are each given in arbitrary units, e.g., mm. FIG. 8 shows in particular that the proposed method is also suitable for measuring or characterizing hot, transparent or semitransparent objects.

FIG. 9 to FIG. 11 show a structure, by way of example, of a k-clock interferometer of a k-clock unit as well as implementations, by way of example, of the k-clock unit in an OCT system.

FIG. 9 shows a k-clock interferometer 29 of a k-clock unit for generating a k-clock signal, for example for use in k-clock-based resampling. The k-clock interferometer 29 is constructed as a planar surface interferometer in the manner of a Fabry-Pérot interferometer, and accordingly is also referred to herein as a k-clock Fabry-Pérot interferometer or simply as a Fabry-Pérot interferometer.

The k-clock interferometer 29, hereinafter also referred to for short as interferometer 29, comprises a spacer 30 with a hollow cylindrical spacer body 30 with an inner hollow-cylindrical gap 32 or air gap 32. At the two distal ends 33 of the spacer body 31, flat surfaces are formed which, for example, have a parallelism of less than 0.005 degrees, i.e., a deviation in the parallelism of less than 0.005 degrees. The spacer 30 or the spacer body 31 is made of a material with an ultra-low temperature coefficient of expansion, for example a material with thermal expansion coefficients in the region of +/−2*10⁻⁷/C.

A first mirror 34 and a second mirror 35 are attached to the distal ends 33 facing away from one another, for example by means of stress-free retaining rings 36 or retaining bodies which press the mirrors 34, 35 onto the respective bearing surfaces of the distal ends 33. The length of the spacer 30 or the spacer body 31 can be e.g., 95 mm, for example, for an oscillation frequency of the k-clock of or in the range of 1.58 GHZ. Suitable materials are for example those mentioned above or in the following.

The mirrors 34, 35 are wedge-shaped and provided with an anti-reflective coating, so that the mirrors 34, 35 as such do not form an etalon, but rather the gap or air gap 32, whose axial length is given by the length of the spacer body 31, or the air or vacuum contained in the air gap 32, forms an etalon which is defined by the optical path length between the mirrors 34, 35.

Mirror surfaces S of the mirrors 34, 35 are plane-parallel and preferably have an angular error of at most 0.002 degrees. The mirror surfaces preferably have an average roughness of 1.5 nm (root mean square, rms) or less. The mirrors 34, 35 are designed as transparent mirrors or semitransparent mirrors.

For coupling and decoupling laser light into and from the k-clock interferometer 29, or in the region of the mirrors 34, 35, so-called tip-tilt devices or mechanisms can be provided, with which, for example, light guides used to supply/discharge the laser light to or from the k-clock interferometer 29 can be inclined or tilted with respect to two axes. The tip-tilt devices may further comprise adjustment mechanisms that enable adjustment in the x-y direction, e.g., perpendicular to the optical axis.

To avoid influences of the surroundings, such as pressure, humidity, etc., on the gap 32 or air gap 32, the mirrors 34, 35 can be sealingly connected to the spacer body 31, for example by anodic joining, by optical contact bonding or by cementing.

FIG. 10 and FIG. 11 show an implementation, by way of example, of a k-clock unit 38 in an OCT system. FIGS. 10 and 11 each show a laser light source or laser 2, specifically a swept-source laser, a beam splitter 39, a k-clock interferometer 29 and an ultrafast detector 40.

Structure and function of the arrangement according to FIG. 10 is as follows:

The laser 2 is light-optically coupled, e.g., by means of a light guide, to an input SE of the beam splitter 39. A first output SA1 of the beam splitter 39 is light-optically coupled to the k-clock interferometer 29, specifically to an input C1 of the k-clock interferometer 29 associated with the first mirror 34, for coupling in laser light via the first mirror 34. A second output SA2 of the beam splitter 39 is, as indicated by the arrow, light-optically coupled to the OCT sensor head.

An input DE of the detector 40 is light-optically coupled to the k-clock interferometer 29 at C2, an output of the k-clock interferometer 29 associated with the second mirror 35, so that interferometry signals can be guided to the detector 40 and evaluated by it.

In the embodiments, all light-optical couplings or connections are preferably implemented by light guides.

An output DA of the detector 40 is connected to an evaluation unit or signal evaluation, in particular an evaluation unit or data processing unit, for generating a k-clock signal. This is indicated schematically by the arrow.

In the present example, the beam splitter 39 is designed such that a portion of 1% of the laser radiation reaches the k-clock interferometer 29 via the first output SA1 of the beam splitter 39, and a portion of 99% of the laser radiation reaches the OCT sensor head via the second output SA2.

The arrangement shown in FIG. 10 as well as the arrangement shown in FIG. 11, which is explained in more detail below, allows for efficient and accurate data acquisition based on a stable k-clock signal.

The arrangement or structure according to FIG. 11 differs from that shown in FIG. 10 in that the detector 40 according to FIG. 11 is implemented as a symmetric or balanced detector, or that a balanced detection or a balanced detector is used.

Specifically, the detector 40 according to FIG. 11 has two inputs, a first input DE1 and a second input DE2. The second input DE2 is, analogously to FIG. 10, light-optically coupled to an output C2 of the k-clock interferometer 29 associated with the second mirror 35. The first input DE1 is also connected to the k-clock interferometer 29, but not to the output C2 but rather to an output of the k-clock interferometer 29 associated with the first mirror 34, which is designated C1*.

In the optical path between the beam splitter 39, k-clock interferometer 29 and detector 40, a circulator 41 is arranged, which has three ports P1, P2, P3. In this case, the first output SA1 of the beam splitter is light-optically coupled or connected to the first port P1, the second port P2 to the input C1/output C1* of the k-clock interferometer 29, and the third port P3 to the first input DE1 of the detector 40. Laser light entering at the port P1 from the beam splitter 39 reaches the input C1 of the k-clock interferometer 29 via the port 2. Laser light arriving from the output C1* of the k-clock interferometer 29 at the port P2 reaches the first input DE1 of the detector 40 via the third port P3.

The optical path length between the output C1* and the first input DE1, and also between the output C2 and the second input DE2, are preferably identical or substantially identical.

By using a balanced or symmetric detection, as shown in FIG. 11, it is possible to improve the signal-to-noise ratio and suppress interference signals.

With the proposed k-clock unit, which may comprise, for example, the k-clock interferometer and the associated detector, comparatively stable k-click signals can be obtained, which in turn leads to improved measurement results. In particular, it can be achieved that the free spectral range (FSR) of the k-clock unit, and thus the length scale of the measurement, is substantially constant and independent of environmental influences such as temperature or pressure fluctuations.

Due to the extremely low thermal expansion coefficient of the spacer, temperature changes have little effect on its length. The influence of temperature, pressure and humidity on the refractive index of the air inside the spacer, for example, can be considered as a remaining factor for changes in the FSR. In order to minimize or eliminate such effects, too, the mirrors can be sealed with respect to the surroundings, with the spacer, by anodic bonding, optical contact bonding or cementing, and thus the gap or air gap.

The proposed k-clock unit can be implemented as shown in FIGS. 10 and 11, comparatively easily into the OCT system described above. For this purpose, e.g., a small part (~1%) of the laser light can be sent to an input, e.g., a light guide fiber input of the k-clock. Output signals, e.g., from a light guide fiber output of the k-clock, can be measured with a fast optical detector or receiver. As mentioned, balanced or symmetric detection can be used to increase the signal-to-noise ratio and to remove interference signals. In balanced detection, an optical circulator provides access to both outputs of the k-clock interferometer, which can be measured with the balanced or symmetric detector.

In balanced or symmetric detection, the amplitudes of the respective signals, i.e., the signals of the two outputs of the k-clock interferometer, are preferably adjusted in front of the detector, for example with fiber attenuators. The optical path lengths between the inputs of the detector and the respective outputs of the k-clock are particularly preferably of equal length.

From the embodiments it becomes clear in particular that the method proposed herein and the optical coherence tomography system enable reliable measurement and geometric characterization of objects, and are suitable for determining not only relative object geometries but also absolute distances with respect to the measuring system and the object. Furthermore, the method is suitable for characterizing hot and/or moving objects. In particular, the method is suitable for characterizing objects, e.g., during a manufacturing process, the characterization substantially being able to be carried out in real time.

### A. REFERENCE SIGNS

1 object
2 swept-source laser or laser
3 circulator
4 collimator
5 beam splitter
6 first output
7 second output
8 power monitoring unit
9 variable optical attenuator
10 high-speed detector
11 October signals
12 laser radiation
13 stationary, partially reflecting optical unit, stationary reference substrate
14 galvanometer scanner or scanner
15 microlens array
16 further beam splitter
17 terminals of further beam splitters
18 further variable optical attenuator
19 retroreflector
20 K-Clock
21 resampling
22 adjustment of start times
23 zero-phase low-pass filtering
24 calculation of phase evolution
25 extraction of the phase profile (“phase unwrapping”)
26 applying a window function
27 fast Fourier transformation (FFT)
28 October periodogram
29 k-clock interferometer
30 spacer
31 spacer body
32 gap/air gap
33 distal end
34 first mirror
35 second mirror
36 retaining ring
37 tip-tilt device
38 k-clock unit
39 beam splitter
40 detector
41 circulator
t time
W wall thickness
ID Inner diameter
AD Outer diameter
D distance
OS OCT signal strength
X point of impact, point
C1 k-clock interferometer input
C2 k-clock interferometer output
C1* k-clock interferometer output
DE Input detector
DE1 detector first input
DE2 detector second input
DA detector output
SE beam splitter input
SA1 beam splitter first output
SA2 beam splitter second output
P1-P3 ports, circulator
S mirror surface

1. A method for optically characterizing a transparent or semitransparent object, in which object dimensions (W, ID, AD), object distances and/or object positions are determined on the basis of optical coherence tomography, wherein, as a light source, a swept-source laser source having a coherence length in the decimeter range to meter range is used, and in order to determine absolute distances, dimensions and/or positions, a reference substrate is used in the beam path of the light source, the reference substrate comprising a partially reflecting optical unit which is stationary in the beam path.

2. The method according to claim 1, wherein the swept-source laser source comprises a MEMS VCSEL-based light source or an akinetic laser light source and/or in that the coherence length is in the range from 0.2 m to 100 m or more.

3. The method according to either claim 1, wherein during signal acquisition and/or signal evaluation of the coherence tomography
a. k-clock resampling is used,
b. minima, maxima or zero crossings of the k-clock of the laser source are determined algorithmically and used as a sampling clock, or
c. a k-clock hardware trigger is used.

4. The method according to claim 1, wherein in the optical coherence spectroscopy, the object is scanned with laser light of the light source using a galvanometer scanner, using a microlens array and/or a bifocal lens, preferably with a high numerical aperture.

5. The method according to claim 1, wherein the object is moved, and a scanning path used in scanning the object at least partially follows the movement of the object and in that, preferably, the data recording of the optical coherence tomography is synchronized with the scanning path.

6. The method according to claim 1, wherein a spatial jitter is superimposed on the scanning path.

7. The method according to claim 5, wherein multiple, in particular a plurality of, reflection profiles obtained along the scanning path are combined, periodogram signals are determined from the combined reflection profile thus obtained, and at least one object dimension (W, ID, AD), at least one object distance and/or at least one object position is/are determined from at least one periodogram signal.

8. The method according to claim 1, wherein an infrared filter, preferably a dual-band mirror, is arranged in the beam path of the light source and thermal radiation emanating from the object and/or the object surroundings in the range of the far infrared spectrum is at least predominantly filtered out using the infrared filter.

9. The method according to claim 1, wherein the optical coherence tomography comprises a signal recording of the k-clock with a software-based filtering and an offset correction, and furthermore, optionally, comprises a subsequent phase extraction, in particular based on a Hilbert transformation and/or an evaluation of zero crossings and extrema, the filtering optionally further comprising low-pass filtering.

10. The method according to claim 1, wherein periodogram signals are determined from signals of the optical coherence tomography by means of an automatic peak-picking algorithm from periodogram data, and at least one object dimension (W, ID, AD), at least one object distance and/or at least one object position is/are determined from the periodogram signals, in particular taking into account periodogram signals of the reference substrate.

11. An optical coherence tomography system designed for optically characterizing a transparent or semitransparent object on the basis of optical coherence tomography, comprising at least one swept-source laser source with a coherence length in the range from 0.2 m to 100 m or in particular in the meter range, a reference substrate arranged in the beam path of the at least one light source, the reference substrate comprising a partially reflecting optical unit which is stationary in the beam path, and a control unit with a processing unit, in particular a processing unit with an architecture for parallel data processing, and a memory associated with the processing unit, the memory comprising instructions that, when executed by the processing unit, bring about a method according to claim 1.

12. The optical coherence tomography system according to claim 11, wherein
the swept-source laser source comprises a MEMS VCSEL-based light source or an akinetic laser light source,
a coherence length of the light source is in the range from 0.2 m to 100 m or more, and/or
the light source has a bandwidth in the range from 20 nm to 100 nm, and/or of at least 40 nm, and/or is designed for repetition rates in the range from 4 kHz to 4 MHz, in particular of approximately 10 KHz.

13. The optical coherence tomography system according to claim 11, furthermore comprising at least one galvanometer scanner designed to scan the object and/or at least one microlens array designed to scan the object.

14. The optical coherence tomography system according to claim 11, furthermore comprising at least one infrared filter arranged in the beam path of the light source, preferably a dual-band mirror, which is designed to at least predominantly filter out thermal radiation emanating from the object and/or the object surroundings in the range of the far infrared spectrum.

15. The optical coherence tomography system, in particular according to claim 11, comprising a k-clock unit for generating a k-clock signal for signal acquisition and/or signal evaluation of the coherence tomography, wherein the k-clock unit has a Fabry-Pérot interferometer which comprises a first mirror, a second mirror and a spacer, wherein the mirrors are attached to sides of the spacer facing away from one another and spaced apart from one another by the spacer, and mirror surfaces (S) of the mirrors-face the spacer and are aligned plane-parallel to one another, wherein the first and second mirrors are preferably wedge-shaped.

16. The optical coherence tomography system according to claim 15, wherein the spacer is made of or consists of a material which has a negligibly low thermal expansion coefficient, in particular is made of or consists of a material for which temperature-related changes in length of the spacer in the relevant operative temperature range, in particular perpendicular to the mirror surfaces (S), are negligible in relation to the wavelengths of the laser light from the swept-source laser source, wherein the material preferably has a thermal expansion coefficient in the range from −2*10⁻⁷/K to 2*10⁻⁷/K.

17. The optical coherence tomography system according to claim 16, wherein the spacer is hollow-cylindrical and forms a hollow-cylindrical gap or air gap between the mirror surfaces (S), wherein the gap or air gap is sealed in the region of the contact surface or bearing surface between the mirrors and the spacer by anodic joining, by optical contact bonding or by cementing.

18. The optical coherence tomography system according to claim 16, wherein a beam splitter connected to the light source on the one hand and to the k-clock unit-on the other hand is provided for feeding the k-clock unit, in particular the Fabry-Pérot interferometer, with laser light from the light source, wherein the beam splitter is preferably designed to feed the k-clock unit, via an input (C1) associated with the first mirror, with a proportion of the laser light from the light source in the range from 0.5% to 2%, in particular of approximately 1%, and/or
comprising a detector with at least one input (DE) which is light-optically coupled to an output associated with the second mirror of the k-clock unit, in particular of the Fabry-Pérot interferometer, for detecting interferometry signals of the Fabry-Pérot interferometer, wherein the optical coherence tomography system further comprises a data processing unit which is designed to evaluate detected interferometry signals and to generate a k-clock signal on the basis of the evaluation.

19. The optical coherence tomography system according to claim 18, wherein, in order to improve the signal-to-noise ratio and to suppress interference signals, the detector is implemented as a balanced detector, wherein, preferably, the balanced detector has two inputs (DE1, DE2), and a first detector input (DE1) is light-optically coupled to an output (C1*) of the Fabry-Pérot interferometer associated with the first mirror, and a second detector input (DE2) is light-optically coupled to an output (C2) of the Fabry-Pérot interferometer associated with the second mirror, wherein the optical coherence tomography system further preferably further comprises a circulator with three ports (P1, P2, P3), wherein the laser light source is light-optically coupled to a first port (P1) for feeding the Fabry-Pérot interferometer with laser light from the laser light source via a second port (P2) of the circulator connected to an input (C1) associated with the first mirror, and the second detector input (DE1) is light-optically coupled to a third port (P3) of the circulator, and the circulator is designed such that interferometry signals of the Fabry-Pérot interferometer emitted via an output (C1*) of the Fabry-Pérot interferometer associated with the first mirror to the second port (P2) are directed via the third port (P2) to the first terminal (DE1) of the detector.
